(19) United States
(12) Patent Application Publication
(10) Pub. No.: US 2005/0022643 A1
(43) Pub. Date: Feb. 3, 2005

(54) Method for separating work pieces

(76) Inventor: Gerd-Jurgen Weidner, Inzighofen-Vilsingen (DE)

Correspondence Address: BACHMAN & LAPOINTE, P.C., 900 CHAPEL STREET, SUITE 1201, NEW HAVEN, CT, 06510, US

(21) Appl. No.: 10/493,196

(22) PCT Filed: Aug. 29, 2002
(86) PCT No.: PCT/EP02/09635

(30) Foreign Application Priority Data
Oct. 19, 2001 (DE) 101 51 169.8

(51) Int. Cl. B26D 7/06

(52) U.S. Cl. 83/27

(57) ABSTRACT

The invention relates to a method for separating workpieces, in particular forged tins, by means of at least one driving device and one clamping device, in which the work piece is maintained, whereby the work piece is cut through by means of at least one sawing device. According to the method, the workpiece may be rotatably driven in relation to the sawing device, for the separation thereof.

### BACKGROUND OF THE INVENTION

The present invention relates to a method for separating workpieces, in particular forged bushes, with at least one driving device and one clamping device, in which the workpiece is held, the workpiece being cut through with at least one sawing device and, for cutting-through, the workpiece being driven rotatably with respect to the sawing device, and also to an apparatus for carrying out the method.

Such methods and apparatuses are already known on the market in various forms and designs. Circular saws and band saws with which workpieces can be cut through are known. With these, a workpiece is clamped on the machine frame in such a way that it remains immovable during working. In the case of a circular saw, the workpiece is cut through with a rotating saw blade. In the case of a band saw, the workpiece is cut through by means of a moving endless sawing band. In both cases, the tool moves, but the workpiece does not.

It is disadvantageous that a change in the cut shape may occur if the workpiece consists of a hard material and it cannot easily be cut through. Parallelism cannot be achieved on the cut-through workpiece without further finishing work.

To cut completely through a workpiece by means of a rotary driven saw blade, its diameter must either be equal to the diameter of the workpiece to be cut through or else larger by a multiple than that of the workpiece in order that a good cutting performance can be achieved.

Since the saws usually operate at high speed, it is possible in the case of such methods and apparatuses for heat to develop at the workpiece, since both the saw blade and the endless sawing band move only in a small region of the circumference of the workpiece during the cutting-through of the workpiece.

The surface roughness is also not optimal in the case of the aforementioned methods and apparatuses, since the saws do not run uniformly through the workpiece. To achieve good quality, it is therefore essential to carry out finishing work on the workpiece, which is undesired.

The larger the workpiece, the longer it takes to cut through the workpiece, whereby on the other hand the costs with regard to wear of the tools, energy, etc. increase. This is time-consuming, costly and energy-intensive, which is undesired.

The object of the present invention is to eliminate the aforementioned disadvantages and provide a method and an apparatus which make it possible to cut through workpieces without finishing work being necessary on the workpiece with regard to surface roughness and parallelism. It is likewise desired for the saw blade to pass through the workpiece with low wear. Furthermore, the development of heat at the workpiece and at the tool is to be minimized. Furthermore, the working time is to be reduced considerably.

DE 29 49 921 discloses an apparatus for mechanically working the circumference of workpieces in the form of rings or bushes, in which the workpiece to be worked on is moved with respect to a tool or a cutting tool.

U.S. Pat. No. 4,412,401 discloses an apparatus for cutting through tubes of relatively large diameter, a tube resting on corresponding roller elements, and it being possible for it to be cut to length by means of a circular cross-cut saw by turning of the tube.

A similar machine for cutting through tubes is disclosed by U.S. Pat. No. 4,901,611, a workpiece that is to be worked resting on two roll elements and it being possible for to be cut through by means of a transversely movable saw.

DE 1 502 693 describes an apparatus for clamping and at the same time turning workpieces on two roll elements, the workpiece being embraced by means of a belt element for driving or for rotary driving. A corresponding rotatably pivotable circular cross-cut saw cuts through the workpiece.

### SUMMARY OF THE INVENTION

The features of the characterizing clauses of claims 1 and 4 lead to the achievement of this object.

The saw blade moves counter to the workpiece, the development of heat being reduced.

Finishing work is no longer necessary on the workpiece, since both the saw blade and the workpiece move on a prescribed path. This has the effect that there is no change in the cut shape, i.e. the parallelism. The surface roughness is now only minimal and the saw blade runs uniformly through the workpiece.

It is also of advantage to reduce the diameter of the saw blade considerably in comparison with the diameter of the workpiece to be cut through, whereby costs and energy are saved. Moreover, the working time for sawing through the workpiece can be reduced significantly.

Since the sawing-through takes place in the case of the present invention without coolants or additives, it is of advantage that chips that are produced can be collected and melted down again without having to be passed on to a separate refining operation.

When this method is used, there is also far less wearing of saw blades than in the case of previously known methods, since the saw blade engages only in the outer, rotating circumferential region of the workpiece.

The apparatus has a drive device which is connected to the clamping device and with which the workpiece to be worked on is held. In addition, the workpiece lies on the rollers of the receiving device. The workpiece is supported on the rollers and held in a resilient and/or damping manner during working.

The rollers of the receiving device rest on elements which permit sprung and/or damped mounting. The rollers themselves may be freely movable or actively driven and have a drive of their own, for example in the form of a servo motor or electric motor.

A linear guide may be used as the guiding device for the movement of the receiving device in the Z direction, but any other guiding device known according to the prior art is possible.

The same applies to the infeeding device in the form of the spindle, which ensures the advancement of the saw blade in the direction of the workpiece. Instead of a spindle, a hydraulic device, a rail or a linear drive may similarly be provided. Here, too, no limits are to be imposed on the invention.

Furthermore, in the case of the apparatus it is possible to provide a catching device, which catches the cut-through workpiece and consequently prevents the saw blade from becoming jammed and damaged.

It is also intended to be within the scope of the present invention for very long forged, preferably multiply forged, bushes to be received on individual rollers or roller elements, in order to saw individual rings off these bushes. In this case it is also intended to be within the scope of the present invention for it to be possible for a plurality of saw blades to be arranged one behind the other or one next to the other, in order to saw a number of rings off the bush simultaneously in the way described above.

Furthermore, it has proven to be advantageous in the case of the present invention to use such apparatuses not only for sawing rings off rolls or forged bushes; turned or drawn round stock, tubes, shafts, etc. can also be worked in the way described above and corresponding rings or disks sawn off.

### BRIEF DESCRIPTION OF THE DRAWINGS

Further advantages, features and details of the invention emerge from the description which follows of preferred exemplary embodiments dots on the basis of the drawing, in which:

FIG. 1 shows a front view of the apparatus for separating workpieces according to the present invention;

FIG. 2 shows a side view of the apparatus according to FIG. 1.

### DETAILED DESCRIPTION

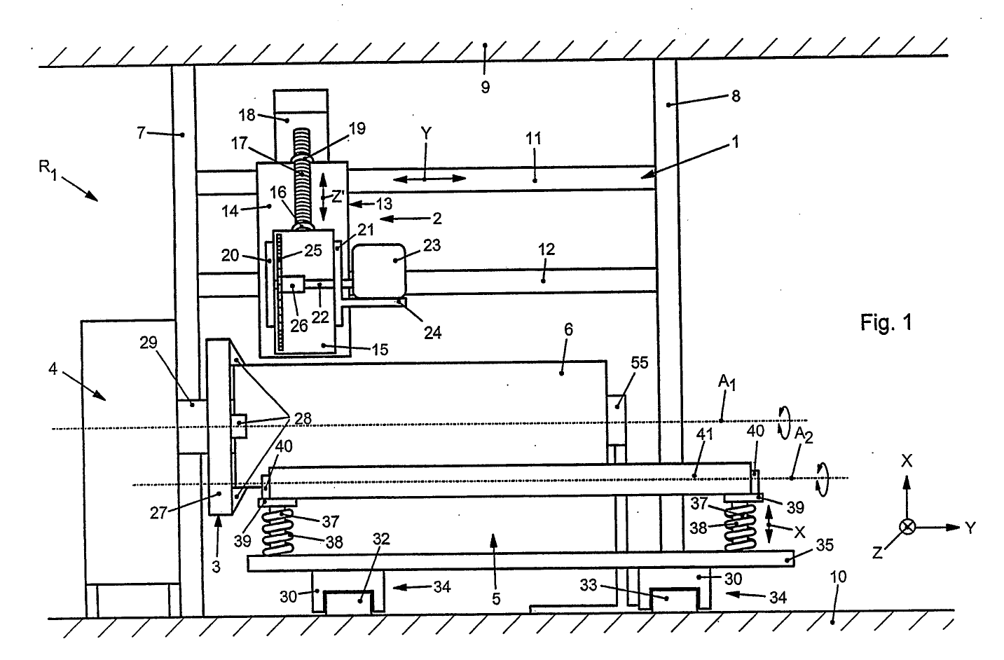

According to FIG. 1, an apparatus R₁ has a machine frame 1, on which a sawing device 2 is movably arranged, and also a clamping device 3 with a driving device 4 and a receiving device 5 for a workpiece 6. Here, the workpiece 6 is a singly or multiply forged copper bush.

The machine frame 1 comprises two side supports 7, 8, which butt with their respective ends against a ceiling 9 and a base 10. Arranged between the two supports 7, 8 are at least two cross members 11, 12.

Arranged on these cross members 11 and 12 is a compound slide 13 of the sawing device 2, which has a base plate 14 and a plate 15 pivotably mounted on it. The compound slide 13 can be made to move with respect to the cross member 11, 12 in a Y direction and is also mounted in such a way that it can be fixed in a desired position.

The plate 15 has on its upper side a guide 16, into which one end of an infeeding device 17, in particular a spindle, enters. The other end of the spindle 17 is connected to a driving element 18. The spindle 17 is guided in a further guide 19, which is assigned to the upper side of the base plate 14.

Arranged spaced apart from one another on the plate 15 are two transverse struts 20, 21, with a shaft 22 which is mounted with its one end in the transverse strut 20 and passes through the transverse strut 21 being provided. With its other end, it is in connection with a driving element 23. This driving element 23 rests on a plate 24 protruding from the transverse strut 21.

On the shaft 22 there is also at least one saw blade 25 arranged displaceably by means of a connecting piece 26.

The clamping device 3 has a frame 27. Fastened on one side of this frame are clamping jaws 28, which firmly clamp the workpiece 6 between them. On the other side, the frame 27 is connected to a drive shaft 29, which connects the frame 27 and consequently the clamping device 3 to the driving device 4.

The receiving device 5, on which the workpiece 6 rests during working, is guided by means of slide elements 30, 31 on guide rails 32, 33. The slide elements 30, 31 and the guide rails 32, 33 together form the guiding device 34. The slide elements 30, 31 can be fixed re-releasably in a desired position with respect to the guide rails 32, 33.

Arranged on the slide elements 30, 31 are two transverse struts 35, 36, in which an element 37 is telescopically mounted respectively at the end. Arranged around the element 37 are springs 38, which bring about additional resilience.

Arranged on each element 37 is a plate 39, on which in turn an element 40 for receiving and mounting rollers 41, 42 is fastened.

The elements 37 with the springs 38 allow a movement of the rollers 41, 42 in the X direction represented. Furthermore, the rollers 41, 42 can be made to move along the guide rails 32, 33 in a Z direction by means of the slide elements 30, 31.

Likewise assigned to the receiving device 5 is a catching device 55, which serves for receiving a sawn-through workpiece. The catching device 55 is fastened in the interior of the workpiece 6 by means of fixing elements 56.

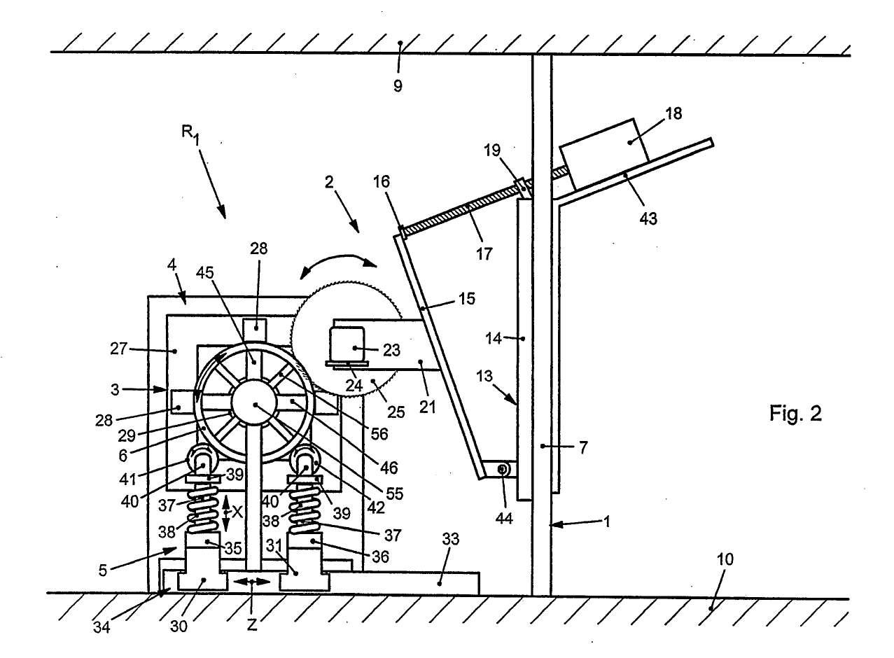

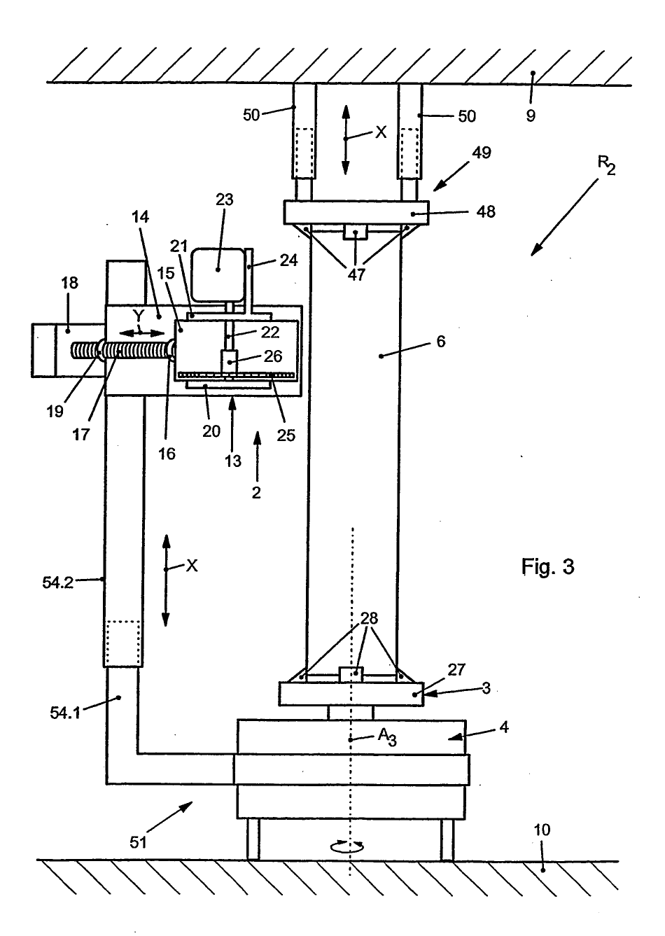

In FIG. 2, a supporting plate 43 is provided for the driving element 18 of the spindle 17, which bears against the base plate 14 of the compound slide 13 of the sawing device 2. Also arranged on the compound slide 13 is a joint 44, which pivotably connects the plate 15 to the base plate 14.

The clamping device 3 has transverse bracing means 45, 46, which are arranged on the frame 27.

In FIG. 3, a further exemplary embodiment of the present invention is represented. There, the workpiece 6 is clamped in a vertical or else horizontal position by the clamping jaws 28 of the clamping device 3 and also if appropriate by further clamping jaws 47.

These clamping jaws 47 are fastened on a frame 48 of a further clamping device 49, which is arranged on the ceiling 9 by means of a telescopic linkage 50. The displacing of this linkage 50 takes place according to the size of the workpiece to be held, for example by means of a piston-cylinder unit.

The driving device 4 to which the clamping device 3 is connected has on its circumference a guiding device 51, which serves for the rotary reception of a holding arm 54.1. The latter can be driven about an axis A₃ in the direction of the double-headed arrow represented.

The holding arm 54.1 is adjoined by a holding arm 54.2, which moves with respect to the latter in a Z direction and on which the sawing device 2 is mounted. Moving of the holding arms 54.1, 54.2 with respect to one another takes place for example by means of a piston-cylinder unit. The sawing device 2 corresponds to the type described above.

The mode of operation of the present invention is as follows:

The workpiece 6 is placed on the rollers 41 and 42 of the receiving device 5 and clamped in the clamping device 3 by the clamping jaws 28. Depending on the size of the workpiece 6, the rollers 41, 42 of the receiving device 5 may be moved apart or toward one another by means of the guiding device 34 in the Z direction represented, so that the rollers 41, 42 bear off-center and laterally against the workpiece 6. They support the workpiece 6 during working, since the surface of the latter is not uniform.

The clamping device 3 together with the clamped workpiece 6 is subsequently set in rotation about an axis A₁ by the driving device 4 by means of the drive shaft 29.

If the workpiece 6 is driven, the rollers 41 and 42 also rotate under the workpiece 6 about an axis A₂ in each case. The connection of these rollers 41, 42 to the element 37 and the springs 38 has the effect of absorbing shocks which may occur due to irregularities of the surface on the workpiece 6, in particular in the case of forged bushes.

In order to saw through the workpiece 6 at a desired point, the sawing device 2 on the machine frame 1 is manually and/or automatically made to move into the desired position.

Once the sawing device 2 is in the desired position, the plate 15 is moved by the spindle 17, which is driven by the driving element 18, about the joint 44 so far in the direction of the arrow Z′ that the saw blade 25 engages in the workpiece 6. The saw blade 25 is driven by means of the driving element 23 during the infeeding of the plate 15 and can saw through the workpiece 6, the workpiece 6 being driven during the sawing operation. The advancement of the sawing device 2 or of the saw blade 25 takes place continuously and controllably, while the workpiece 6 is rotatably driven.

It should be emphasized particularly here that the driving movements of the saw blade 25 and of the workpiece 6 are counter to one another, so that faster sawing-through of the workpiece 6 can be carried out.

It is also intended to be within the scope of the present invention for example for the workpiece 6 to be clamped between three roller elements 40, 41 if appropriate of a clamping roller resting on top, it then being possible if appropriate to dispense with the driving device 4. This is then driven for example by one of the three rollers 41, 42. This is likewise intended to be within the scope of the present invention.

In the case of the further exemplary embodiment according to FIG. 3, the workpiece 6 is not set in rotation, but is firmly clamped between the clamping jaws 28 of the clamping device 2 and the clamping jaws 47 of the clamping device 49. The workpiece 6 is fixed.

The holding arm 54.1, which is adjoined by the holding arm 54.2, is driven in a controllable manner rotatably around the driving device 4 about the axis A₃.

Mounted on the holding arm 54.2 is the sawing device 2, which can also be made to move with respect to the holding arms 54.1, 54.2 in an X direction for the setting of a desired position.

For sawing through the workpiece 6, the holding arm 54.1, 54.2 with the sawing device 2 fastened to it rotates about the axis A₃ around the workpiece 6 and in this way cuts through the workpiece 6 at any desired height with a saw blade 25 preferably driven counter to it, with infeeding of the sawing device 2 toward the workpiece 6.

1-20. (cancelled)

21. A method for separating workpieces, in particular forged bushes, with at least one driving device and one clamping device in which the workpiece is held, the workpiece being cut through with at least one sawing device and, for cutting through, the workpiece is driven rotatably with respect to the sawing device, wherein, during cutting through, the workpiece is at least one of rotatably mounted and held by means of at least one receiving device and the at least one receiving device is mounted in at least one of a resilient and a damping manner with respect to a base, while the sawing device is moved with at least one infeeding device toward the workpiece and toward the receiving device.

22. The method as claimed in claim 21, wherein, for cutting through the workpiece, at least one saw blade is driven counter to one of the rotary movement of the workpiece and rotary movement of the sawing device.

23. The method as claimed in claim 21, wherein the at least one receiving device is made to move in an at least one of X direction and a Z direction toward the workpiece for coming to bear against, supporting and mounting the workpiece.

24. An apparatus for separating workpieces, in particular forged bushes, with at least one driving device and one clamping device for holding a workpiece, at least one sawing device being provided for cutting through the workpiece, the workpiece being driven rotatably with respect to the sawing device, wherein, during cutting through, the workpiece is at least one of rotatably mounted and clamped on at least one receiving device and the at least one receiving device is mounted in at least one of a resilient and a damping manner with respect to a base, and wherein the sawing device can be moved with at least one infeeding device toward the workpiece and toward the receiving device.

25. The apparatus as claimed in claim 24, wherein, for cutting through the workpiece, the at least one saw blade can be driven counter to rotary movement of the workpiece.

26. The apparatus as claimed in claim 24, wherein the at least one receiving device can be made to move in at least one of an X direction and a Z direction toward the workpiece for coming to bear against, supporting and mounting the workpiece.

27. The apparatus as claimed in claim 24, wherein the receiving device is assigned the clamping device, which receives the workpiece substantially parallel to the base.

28. The apparatus as claimed in claim 24, wherein the driving device is adjoined at the end face by the receiving device, with each receiving device being assigned slide elements which can be moved along guide rails in a Z direction.

29. The apparatus as claimed in claim 28, wherein the slide elements are respectively interconnected by means of transverse struts.

30. The apparatus as claimed in claim 29, wherein at least one element is provided at both ends of the transverse struts, between which in each case rollers are at least one of actively driven or mounted in a freely rotatable manner.

31. The apparatus as claimed in claim 30, wherein the rollers can be moved with respect to the transverse struts in a Y direction.

32. The apparatus as claimed in claim 30, wherein the transverse struts or the respective rollers can be moved along guide rails in the Z direction and fixed.
